(19) United States
(12) Patent Application Publication
(10) Pub. No.: US 2015/0329688 A1
(43) Pub. Date: Nov. 19, 2015

(54) THERMALLY STABLE POROUS MEDIUM

(71) Applicant: E.I.DU PONT DE NEMOURS AND COMPANY, Wilmington, DE (US)

(72) Inventor: Srinivas Cherukupalli, Andhra Pradesh (IN)

(21) Appl. No.: 14/651,956

(22) PCT Filed: Dec. 20, 2013
(86) PCT No.: PCT/US2013/076777

§ 371 Date: Jun. 12, 2015

(30) Foreign Application Priority Data
Dec. 21, 2012 (IN) 3983/DEL/2012

(51) Int. Cl. C08J 7/04; B05D 1/18; C09D 133/08; B05D 1/02; C09D 175/04; B05D 3/00; B05D 1/28

(52) U.S. Cl. CPC C08J 7/047; B05D 3/007; B05D 1/18; B05D 1/28; B05D 1/02; C09D 175/04; C09D 133/08; C08J 2323/06; C08J 2433/08; C08J 2475/04

(57) ABSTRACT

A flash spun non-woven polyethylene is coated with suitable thermally stable coating to make the non-woven polyethylene suitable for high temperature applications including digital printing and also a method for preparation of such thermally stable non-woven polyethylene.

This application claims the benefit of Indian provisional Application 3983/DEL/2012, filed Dec. 21, 2012 which is herein incorporated by reference.

### BACKGROUND OF THE INVENTION

1. Field of the Invention

The present invention relates to improvement of the thermal stability of a polyethylene planar substrate using suitable coatings.

2. Description of the Related Art

The use of nonwoven fabrics as a printing medium has been proposed in various prior patent documents, such as for example, U.S. Pat. No. 5,240,767, U.S. Pat. No. 5,853,861 and U.S. Pat. No. 6,210,778. However, little attention is given to the structural and physical properties of the nonwoven fabric required to make the fabric a commercially acceptable substrate for digital printing applications. One of the problems inherent with the manufacture of nonwoven fabrics by conventional manufacturing methods is that the fiber deposition can be uneven or variable, producing thick and thin spots or other variations in basis weight that render the material unappealing or unsuitable for use as a printing medium. As a result, very few nonwoven fabrics have found commercial acceptance as a printing medium.

US Patent Publication 2004/0248492 A1 discloses a nonwoven printing medium made by laminating two or more nonwoven layers together to provide sufficiently uniform thickness and basis weight and sufficient structural properties to be suitable for use in various commercial printing operations such as, for example, ink-jet printing and laser printing, as well as the more traditional printing technologies of flexography, lithography, letterpress printing, gravure and offset.

U.S. Pat. No. 6,210,778B1 discloses a laser printable non-woven polyester fabric coated with a polyurethane or polyurethane-polyester blend coatings. The coating weight disclosed in '778 is high (2.5 oz/yd) and adds significant basis weight to the fabric.

There is a need for a laser printable substrate that shows little or no shrinkage when printed.

### SUMMARY OF THE INVENTION

An aspect of this invention is a layer of polyethylene and a layer of a coating, the layer of coating comprising a cross-linked polymer covering at least a portion of the surface of the layer of polyethylene, wherein the coating has a weight of 80 gsm or less.

In one embodiment of the invention, the substrate shows less than 15% dimensional change in either the longitudinal or transverse directions when subjected to a thermal stability test in which the substrate is printed upon in a laser printer.

In another embodiment of the invention, the substrate shows no dimensional change in longitudinal or transverse direction when subjected to a thermal stability test in which the substrate is printed upon in a laser

In another embodiment of the present invention, the substrate shows no dimensional change in longitudinal or transverse direction when subjected to a thermal stability test in which the substrate is printed upon in a laser In an embodiment of the present invention, the cross-linked coating is selected from the group consisting of vinyl ester, unsaturated polyesters, alkyds, epoxies, phenolic resin, polyisocyanate, polyurea, polyacrylates, polyamides, perfluoro acrylates, cyanoacrylates, polyurethane polyethylene, cellulose, and combinations.

In another embodiment of the present invention, the polyethylene planar substrate is in a form selected from the group consisting of film, woven, non-woven and any combination thereof.

In a further embodiment the polyethylene planar substrate comprises a plexifilamentary web.

In still another embodiment of the invention, the coating further comprises fillers that are selected from the group consisting of sodium acetate, potassium acetate, sodium iodide, calcium sulfate, silica, calcium carbonate, titanium dioxide, silver nanoparticles, photoluminiscent materials, UV reactive pigments, carbon black and any combination thereof.

In another embodiment, the polyethylene is metallized on at least one side prior to coating.

Another aspect of this invention is a process for preparing a planar substrate, comprising the steps of:
I. providing a planar polyethylene substrate,
II. applying a coating solution to the polyethylene substrate,
III. curing the coated polyethylene at a temperature between 20 and 130° C., and
IV. annealing the coated polyethylene at a temperature between 75 and 130° C.

wherein the coating solution is applied in a solution to the layer of polyethylene.

In one embodiment of the present invention, in the process for preparing a planar substrate, the coating is applied by a process selected from dip coating, knife coating, brush coating, gravure coating, Meyer rod coating, spray coating and combinations thereof.

### DETAILED DESCRIPTION OF THE INVENTION

Applicant specifically incorporates the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof and all integers and fractions within the range. It is not intended that the scope of the invention be limited to the specific values recited when defining a range.

The present invention is directed to a planar substrate comprising a layer of polyethylene and a layer of a coating, the layer of coating comprising a cross-linked polymer covering at least a portion of the surface of the layer of polyethylene, wherein the coating has a weight of 80 gsm or less.

For purposes of describing the features of the coated polyethylene described herein, the term “coating’ is defined as a material layer in adherence with either surface (one or both sides) or bulk morphology of a porous substrate.

The term “planar substrate” as used herein refers to a substrate which has first and second opposite sides and lies generally in a plane. For purposes of this disclosure, a first side of the substrate is said to be “opposite” a second side of the substrate if said first and second sides lie in generally parallel planes and are separated by an edge, which is the thickness of the substrate.

“Cross-linkable” refers to polymer chains bonded to other chains at multiple points producing a highly interlinked structure.

“Dimensional change” refers to change in longitudinal or transverse direction dimensions when exposed to elevated temperatures.

“Porous” refers to a material that has a significant amount of voids, capillaries, communicated holes, and/or fissures.

“Laminate” refers to a material layer in adherence with only surface morphology of a primary porous substrate and can be considered as a synonym of “coating”.

‘Thermal stability test” refers to test method used to determine the dimensional changes of the coated polyethylene substrate based on the application. The thermal stability tests are described in detail in the test method section.

The term “nonwoven” means here a web including a multitude of randomly oriented fibers. By “randomly oriented” is meant that the fibers have no long range repeating structure discernable to the naked eye. The fibers can be bonded to each other, or can be unbonded and entangled to impart strength and integrity to the web. The fibers can be staple fibers or continuous fibers, and can comprise a single material or a multitude of materials, either as a combination of different fibers or as a combination of similar fibers each comprised of different materials.

Nonwoven fabrics or webs have been formed from many processes such as for example, meltblowing processes, spunbonding processes, and bonded carded web processes. The basis weight of nonwoven fabrics is usually expressed in ounces of material per square yard (osy) or grams per square meter (gsm) and the fiber diameters useful are usually expressed in micrometers. (Note that to convert from osy to gsm, multiply osy by 33.91).

As used herein the term “microfibers” means small diameter fibers having an average diameter not greater than about 75 micrometers, for example, having an average diameter of from about 0.5 micrometers to about 50 micrometers, or more particularly, microfibers may have an average diameter of from about 2 micrometers to about 40 micrometers. The diameter of, for example, a polypropylene fiber given in micrometers, may be converted to denier by squaring, and multiplying the result by 0.00629, thus, a 15 micrometer polypropylene fiber has a denier of about 1.42 (15²×0.00629=1.415).

As used herein the term “spunbond fibers” refers to small diameter fibers which are formed by extruding molten thermoplastic material as filaments from a plurality of fine, usually circular capillaries of a spinnerette with the diameter of the extruded filaments then being rapidly reduced as by, for example, U.S. Pat. No. 4,340,563 to Appel et al., U.S. Pat. No. 3,692,618 to Dorschner et al U.S. Pat. No. 3,802,817 to Matsuki et al., U.S. Pat. No. 3,338,992 U.S. Pat. No. 3,341,394 to Kinney, U.S. Pat. No. 3,502,763 and U.S. Pat. No. 3,542,615 to Dobo et al. Spunbond fibers are generally continuous and larger than 7 micrometers, more particularly, they are usually between about 15 and 50 micrometers.

The substrate of the invention may comprise a plexifilamentary web. The term “plexifilamentary” refers to a planar structure which is characterized by a morphology substantially consisting of a three-dimensional integral network of thin, ribbon-like, film-fibril elements of random length that have a mean film thickness of less than about 4 micrometers and a median fibril width of less than 25 micrometers, and that are generally coextensively aligned with the longitudinal axis of the yarn. In plexifilamentary yarns, the film-fibril elements intermittently unite and separate at irregular intervals in various places throughout the length, width and thickness of the yarn, thereby forming the three-dimensional network.

U.S. Pat. No. 3,081,519 to Blades et al. describes a process wherein a solution of fiber-forming polymer in a liquid spin agent that is not a solvent for the polymer below the liquid's normal boiling point, at a temperature above the normal boiling point of the liquid, and at autogenous pressure or greater, is spun into a zone of lower temperature and substantially lower pressure to generate plexifilamentary film-fibril strands. As disclosed in U.S. Pat. No. 3,227,794 to Anderson et al., plexifilamentary film-fibril strands can be obtained using the process disclosed in Blades et al. when the pressure of the polymer and spin agent solution is reduced slightly in a letdown chamber just prior to flash-spinning.

In a laser printing machine, the toner particles atop a printable substrate such as paper are melted and impregnated into the porous substrate through simultaneous application of high temperature (150-220° C.) and pressure (100-150 pounds per square inch or 690 to 1034 kPa.) This step is accomplished at the fuser section of a laser printer and lasts approximately between 0.5 and 5 seconds, depending on the speed of printing and printing engine design.

For a polyolefin non-woven substrate to be used in this application, it is imperative that the substrate withstand the fuser conditions. Else, the substrate can melt, shrink, or curl and jam the printing process. Since the melting point (Tₘ) of polyethylene is about 135° C. (when tested in a differential scanning calorimeter at a scan rate of 10° C./min), it tends to shrink or melt as the fuser conditions are applied and a laser printable sheet cannot be obtained.

The current invention is intended to improve the thermal stability characteristics of a lower melting point porous substrate (such as a plexifilamentary or spunbond web), so as to withstand temporary application of temperatures over its melting point even at a pressure above atmospheric.

An aspect of this invention is a planar substrate comprising a layer of polyethylene and a layer of a coating comprising a cross-linked polymer covering at least a portion of the surface of the layer of polyethylene, wherein the coating has a weight of 80 gsm or less.

In one embodiment of the invention, the substrate shows less than 15% dimensional change in either the longitudinal or transverse directions when subjected to a thermal stability test in which the substrate is printed upon in a laser printer.

In another embodiment of the invention, the substrate shows no dimensional change in longitudinal or transverse direction when subjected to a thermal stability test in which the substrate is printed upon in a laser.

In an embodiment of the present invention, the cross-linked coating is selected from the group consisting of vinyl ester, unsaturated polyesters, alkyds, epoxies, phenolic resin, polyisocyanate, polyurea, polyacrylates, polyamides, perfluoro acrylates, cyanoacrylates, polyurethane polyethylene, cellulose, and combinations.

In another embodiment of the present invention, the polyethylene planar substrate is in a form selected from the group consisting of film, woven, non-woven and any combination thereof.

In another embodiment of the present invention, the polyethylene planar substrate comprises a plexifilamentary web.

In still another embodiment of the invention, the coating further comprises fillers that are selected from the group consisting of sodium acetate, potassium acetate, sodium iodide, calcium sulfate, silica, calcium carbonate, titanium dioxide, silver nanoparticles, photoluminiscent materials, UV reactive pigments, carbon black and any combination thereof.

In another embodiment, the layer of polyethylene is metallized on at least one side prior to coating.

Another aspect of this invention is a process for preparing a planar substrate comprising the steps of:
providing a planar polyethylene substrate,
applying a coating solution to the polyethylene substrate, curing the coated polyethylene at a temperature between 20 and 130° C., and annealing the coated polyethylene at a temperature between 75 and 130° C.
wherein the coating solution is applied in a solution to the layer of polyethylene.

In one embodiment of the present invention, in the process for preparing a planar substrate, the coating is applied by a process selected from the group consisting of dip coating, knife coating, brush coating, gravure coating, meyer rod coating, spray coating and combinations thereof.

### EXAMPLES

### Test Methods

An A4 size (210 mm×297 mm) coated sample is loaded into the feeder tray of a Canon® LBP2900 B&W laser printer or a Ricoh Aficio 4501 color laser printer. The maximum fuser temperature is about 180° C. as measured using an Infrared camera, with emissivity set at 0.9, pointed at the exposed fuser component. Print command is then given to print 5 lines of text and the A4 sheet travels through toner deposition step and fusing step to give a printed sheet. The coated sample is considered to be thermally stable when less than 10% dimensional change is observed.

### Materials

Flash spun non-woven high density polyethylene webs (Tyvek® 1073D, a 75 g/m² basis weight, and Tyvek® 1082D, 105 g/m² basis weight.) were obtained from E.I. DuPont de Nemours Company, Wilmington, Del. (DuPont)

Polyimide film was obtained from DuPont under the tradename Kapton®.

A water based commercial grade of acrylic emulsion (Premium Acrylic emulsion) was obtained from Asian Paints, India.

A cross-linkable hydrophilic aliphatic polyisocyanate based on hexamethylene diisocyanate (HDI) (Bayhydur XP 2655) was obtained from Bayer® Material Science.

Hydroxyfunctional polyacrylate dispersion (Bayhydrol A 2601) which was used in combination with aliphatic polyisocynates for formulation of waterborne two-component coatings, was obtained from Bayer® Material Science.

A 40 wt % dispersion of colloidal silica (22 nm in diameter) in water (Ludox® 40) was obtained from Sigma-Aldrich.

An aliphatic polyisocyanate based on hexamethylene diisocyanate (HDI) and supplied as 90% in butyl acetate/solvent naphtha 100 (1:1) (Desmodur N 3390 BA/SN), was obtained from Bayer® Material Science.

### Comparative Example A

A polyethylene plexifilamentary web sample (Tyvek® 1073D) was tested for dimensional changes by placing a 2.5″×1.5″ (6.4 cm×3.8 cm) sample on a hot plate. The hot plate was first heated to a temperatures of 140, 150, 160, 170, 180, 190° C. and allowed for 15 min to equilibrate along with two Kapton® polyimide sheets left on the hot plate. After 15 minutes, the web sample was placed between the polyimide sheets on the hot plate with a 1 kg load on the sample for 3 seconds. The Tyvek® sample held at different set temperatures ranging from 140 to 190° C. lost dimensional stability and gradually turned transparent.

### Comparative Example B

15 gm of an acrylic emulsion (Asian Paints, India) was well mixed in 50 cc of DI water and coated on both sides of a plexifilamentary web (Tyvek® 1073D) using a paint brush. The coated sheet was then cured in an oven at 100° C. for 60 minutes to obtain a dry coat weight of 25 g/m². Solvent (Acetone) wash of the dried sample showed that the emulsion coating dissolved completely indicating that no crosslinking had taken place.

Next, the coated sheet was passed through a Ricoh Aficio 4501 color laser printer. However, the substrate lodged at printer's fuser section and the recovered sample showed complete disintegration of non-woven due to high temperature and pressure applied during the printing process.

### Example 1

15 gm of Desmodur® N 3390 was well mixed with 50 cc of Acetone to form a consistent solution. The coating was then applied on a plexifilamentary web (Tyvek® 1073D) using a 16 micrometer Meyer rod and then cured in the oven at 100° C. for 60 minutes. A dry coat weight of about 35 g/m2 was obtained. A solvent wash of the coated sample did not show any dissolution of coating, indicating a formation of highly crosslinked network. Next, the coated sheet was passed through a Ricoh Aficio 4501 color laser printer. The printed sample showed 0% dimensional change.

### Example 2

15 gm of Desmodur® N 3390 was mixed with 10 cc of Acetone to form a consistent solution. The coating was then applied on a plexifilamentary web (Tyvek® 1073D) using a 16 micrometer Meyer rod and then cured in the oven at 100° C. for 120 minutes. A dry coat weight of about 76 g/m² was obtained. A solvent wash of the coated sample did not show any dissolution of coating, indicating a formation of highly crosslinked network. Next, the coated sheet was passed through a Ricoh Aficio 4501 color laser printer. The printed sample showed 0% dimensional change.

### Example 3

10 grams of Bayhydrol XP 2601 (Bayer® Material Science) was mixed well with 50 ml of DI water, followed by 5 grams of Bayhydur XP 2655 and 1 gram of Sodium Acetate. 10 cc of Ludox® 40 aqueous dispersion of colloidal silica were then added to the solution. The composition was then coated on Tyvek® 1082D, on a single side in one instance, and on both sides for another sample. After curing the coated sheets using a hot air gun at 120° C. set point, the samples were printed using a Canon® LBP2900 laser printer. A 0% dimensional change was observed in the printed samples and the sheets also displayed excellent text resolution without any smudging.

### Example 4

A Premium acrylic based paint emulsion (Premier Emulsion®, Asian Paints, India) with nearly 50 wt. % inorganic filler (1:1 wt ratio TiO₂ and CaCO₃) was coated (base coat) on one side of a plexifilamentary web (Tyvek® 1082D) using a paint brush (base coat).

6 gm of Bayhydur XP 2655 was mixed well with 50 cc of DI water, followed by 9 gm of Bayhydrol XP 2601, 10 gm of 50 wt % TiO₂ in water dispersion, and 1 gm of anhydrous Sodium acetate. This dispersion was coated using a paint brush on the same side of plexifilamentary web (Tyvek® 1082D) (top coat) and cured at 100° C. using a hot air gun. The coated sheet was then annealed at a temperature of 120° C. Coat weights of the base and top coats were 15 g/m² and 8 g/m², respectively. The single side coated sheet was printed on a Canon® LBP2900 laser printer. A 0% dimensional change was observed and the printed sheet also showed excellent resolution without any smudging. Upon printing, it was observed that the single side coated sample did not display any curling effect.

1. A planar substrate comprising a layer of polyethylene and a layer of a coating, the layer of coating comprising a cross-linked polymer covering at least a portion of the surface of the layer of polyethylene, wherein the coating has a weight of 80 gsm or less.

2. The planar substrate of claim 1, wherein the substrate shows less than 15% dimensional change in either the longitudinal or transverse directions when subjected to a thermal stability test in which the substrate is printed upon in a laser printer.

3. The planar substrate of claim 2, wherein the substrate shows no dimensional change in longitudinal or transverse direction when subjected to a thermal stability test in which the substrate is printed upon in a laser.

4. The coated polyethylene of claim 1, wherein the cross-linked coating is selected from the group consisting of vinyl ester, unsaturated polyesters, alkyds, epoxies, phenolic resin, polyisocyanate, polyurea, polyacrylates, polyamides, perfluoro acrylates, cyanoacrylates, polyurethane polyethylene, cellulose, and combinations.

5. The planar substrate of claim 1, wherein the polyethylene planar substrate is in a form selected from the group consisting of film, woven, non-woven and any combination thereof.

6. The planar substrate of claim 5, wherein the polyethylene planar substrate comprises a plexifilamentary web.

7. The planar substrate of claim 1, wherein the coating further comprises fillers that are selected from the group consisting of sodium acetate, potassium acetate, sodium iodide, calcium sulfate, silica, calcium carbonate, titanium dioxide, silver nanoparticles, photoluminiscent materials, UV reactive pigments, carbon black and any combination thereof.

8. The substrate of claim 1, wherein the layer of polyethylene is metallized on at least one side prior to the coating.

9. A process for preparing a planar substrate, comprising the steps of:
providing a planar polyethylene substrate,
applying a coating solution to the polyethylene substrate,
curing the coated polyethylene at a temperature between 20 and 130° C., and
annealing the coated polyethylene at a temperature between 75 and 130° C., wherein the coating solution is applied in a solution to the layer of polyethylene.

10. The process for preparing a planar substrate of claim 8, wherein the coating is applied by a process selected from the group consisting of dip coating, knife coating, brush coating, gravure coating, meyer rod coating, spray coating and combinations thereof.
